(19) United States
(12) Patent Application Publication
(10) Pub. No.: US 2017/0266890 A1
(43) Pub. Date: Sep. 21, 2017

(54) ADDITIVE MANUFACTURING DEVICE

(71) Applicant: Incodema3D, LLC, Ithaca, NY (US)

(72) Inventor: Scott Volk, Ithaca, NY (US)

(21) Appl. No.: 15/455,903

(22) Filed: Mar. 10, 2017

Related U.S. Application Data
(60) Provisional application No. 62/308,572, filed on Mar. 15, 2016.

(51) Int. Cl. B29C 67/00; B33Y 30/00; B33Y 50/02; B33Y 10/00

(52) U.S. Cl. CPC B29C 67/0092; B29C 67/0088; B33Y 10/00; B33Y 30/00; B33Y 50/02

(57) ABSTRACT

An additive-manufacturing device includes a build chamber and a build platform that is adjustably coupled to the build chamber. A first subplate is detachably coupled to the build platform by the first securing feature. A second subplate is detachably coupled to the build platform by the second securing feature. The additive-manufacturing device is configured to print a first build piece on the first subplate when the first subplate is detachably coupled to the build platform by the first securing feature.

### CLAIM OF PRIORITY

This application claims priority to U.S. Provisional Application Ser. No. 62/308,572, filed on Mar. 15, 2016, the entire contents of which are hereby incorporated by reference.

### TECHNICAL FIELD

This document relates to additive manufacturing devices, as well as processes of using such devices and articles made by such processes.

### BACKGROUND

Additive-manufacturing is a process of manufacturing whereby a build piece is created by adding a manufacturing medium (e.g., a metal) to a part, as opposed to removing media to create the part. Examples of additive-manufacturing include, but are not limited to, i) additive metal manufacturing, sometimes called powder bed fusion, where a laser or other heat source sinters or melts a metal medium; ii) stereolithography, where a light source cures a photopolymer; and iii) fused deposition modeling, where a thermoplastic is extruded and cools to harden.

### SUMMARY

In one aspect, a system includes an additive-manufacturing device. The additive-manufacturing device includes a build chamber; and a build platform adjustably coupled to the build chamber and comprising a first securing feature and a second securing feature. The system further includes a first subplate detachably coupled to the build platform by the first securing feature. The system further includes optionally, a second subplate detachably coupled to the build platform by the second securing feature. The additive-manufacturing device is configured to print a first build piece on the first subplate when the first subplate is detachably coupled to the build platform by the first securing feature.

Implementations can include any, all, or none of the following features. The system includes the second subplate and the additive-manufacturing device is configured to print a second build piece on the second subplate when the second subplate is detachably coupled to the build platform by the second securing feature. The additive-manufacturing device is configured to pause the printing of the first build piece on the first subplate to allow removal of the second build piece and the second subplate from the second securing feature. The second build piece is a calibration piece. The additive-manufacturing device is configured to modify the printing of the first build piece on the first subplate based on measurements of the second build piece. Modifying the printing of the first build piece includes terminating the printing before completion. Modifying the printing of the first build piece includes modifying a parameter of the printing based on at least one of the measurements of the second build piece. The first or second securing feature includes holes configured to receive fasteners. The first or second securing feature includes a recess in the build platform. The first or second securing feature includes a ball detent interface. The first subplate or the second subplate has an area less than an area of the build platform. The build platform further includes a third securing feature. The system further optionally includes a third subplate.

In one aspect, a method includes providing an additive-manufacturing device that includes a build chamber and a build platform adjustably coupled to the build chamber, the build platform including a first securing feature and a second securing feature, wherein the first securing feature is configured to detachably couple a first subplate to the build platform, and the second securing feature is configured to detachably couple a second subplate to the build platform. The method includes printing first and second build pieces, the printing including i) printing a first build piece on a first subplate detachable coupled to the build platform by the first securing feature and ii) printing a second build piece on a second subplate detachably coupled to the build platform by the second securing feature.

Implementations can include any, all, or none of the following features. The method includes receiving an indication that the printing has completed the second build piece and not completed the first build piece; and responsive to receiving an indication that the printing has completed the second build piece and not completed the first build piece, pausing the printing. The method includes removing the second build piece and the second subplate. The method includes resuming, by the additive-manufacturing device, printing the first build piece after removing the second build piece and the second subplate. Resuming printing the first build piece includes receiving an indication that the second subplate has been removed from the second securing feature. The second build piece is a calibration piece. The method includes modifying, by the additive-manufacturing device, the printing of the first build piece based on measurements of the second build piece. Modifying the printing of the first build piece comprises terminating the printing of the first build piece before completion. Modifying, by the additive-manufacturing device, the printing includes modifying a parameter of the printing based on at least one of the measurements of the second build piece. The first securing feature and the second securing feature both include holes configured to receive fasteners. The first securing feature and the second securing feature both include ball detent interfaces. The first subplate or the second subplate has an area less than an area of the build platform. The build platform further includes a third securing feature.

In one aspect, a method includes providing an additive-manufacturing device that includes a build chamber, a build platform adjustably coupled to the build chamber, and a first subplate, wherein the build platform includes a first securing feature and the first subplate is detachably coupled to the build platform by the first securing feature. The method includes printing first and second build pieces, the printing including i) printing the first build piece on the first subplate and ii) printing the second build piece on the build platform outside the first subplate.

Implementations can include one or more of the following advantages. By pausing a printing when the first of two build pieces is printed, the completed build piece can be removed and used, finished, or shipped without the need to wait for the other build piece to finish printing. By printing on subplates, only the comparatively smaller pint surfaces of the subplates need to be resurfaced before reuse as compared to the larger build platform. By printing a calibration piece along with a larger build piece, the printing of the larger build piece can be validated before completion. This can allow early termination of the printing of out of specification pieces, or mid-printing adjustments to calibrations of the additive-manufacturing device.

### DESCRIPTION OF DRAWINGS

FIG. 1 is a top view of an example build platform with two subplates attached.

FIG. 2 is a top view of an example build platform with one subplate attached.

FIG. 3 is an isometric view of an example subplate.

FIG. 4 is a top view of an example subplate.

FIG. 5 is a canted side view of an example subplate.

FIG. 6 is a top view of an example build platform with four subplates attached.

FIG. 7 is a top view of an example build platform with three subplate attached.

FIG. 8 is a flowchart of an example process for printing build pieces on subplates.

FIG. 9 is a side view of an example build platform.

FIG. 10 is a schematic diagram that shows an example of a computing system.

Like reference symbols in the various drawings indicate like elements

### DETAILED DESCRIPTION

An additive-manufacturing device (e.g., a 3D additive-manufacturing device) can be configured to print build pieces onto subplates that are detachably coupled to the build platform, as opposed to or in addition to printing directly on the build platform, for instance. In some cases, the additive manufacturing device can complete the printing of a small build piece on a subplate before a larger build piece. In such as case, the printing of the larger piece can be paused, the subplate and the smaller build piece can be removed, and the printing of the larger build piece can be continued. In some cases, the smaller build piece can be a calibration piece. This calibration piece can be removed and measured to calibrate the additive-manufacturing device, to determine if the calibration is accurate, etc.

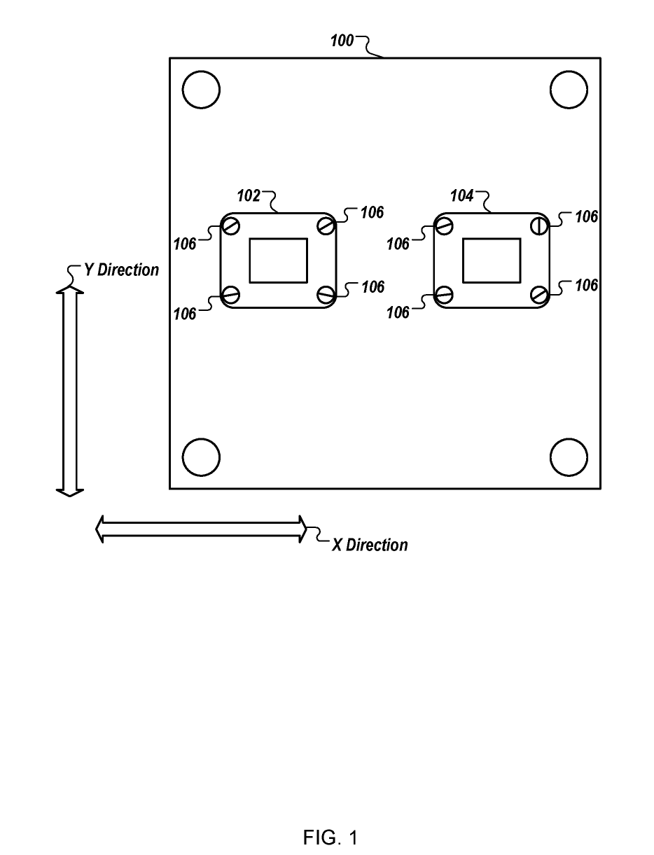

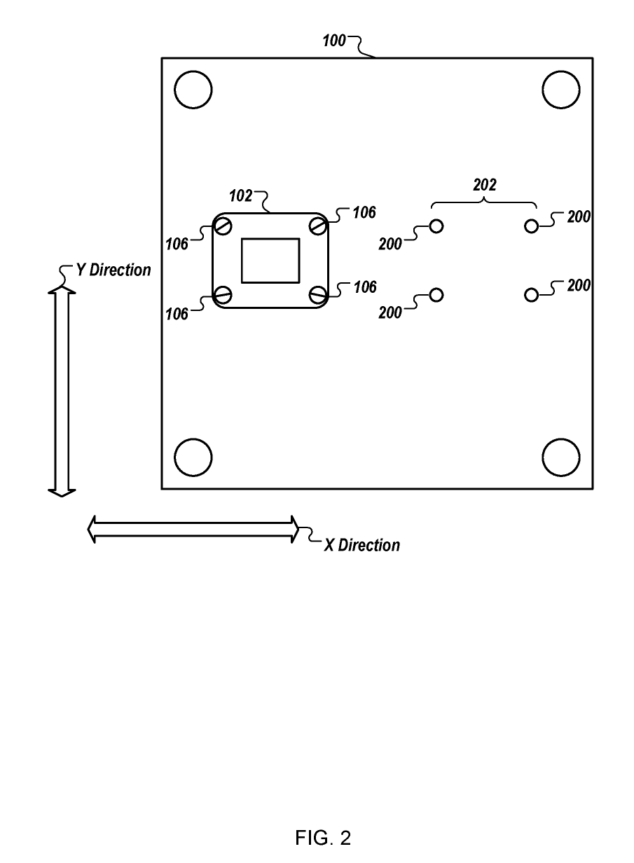

FIG. 1 is a top view of an example build platform 100 with two subplates 102 and 104 attached to the build platform 100 through two securing features. FIG. 2 is a top view of the example build platform 100 with one subplate 102 attached to the build platform 100 through a securing feature, and a securing feature 202 without any subplate attached to it.

The build platform 100 can be, for example, adjustably coupled to a build chamber of an additive-manufacturing device that is configured to print a build piece on the build platform 100 and/or the subplates 102 and 104.

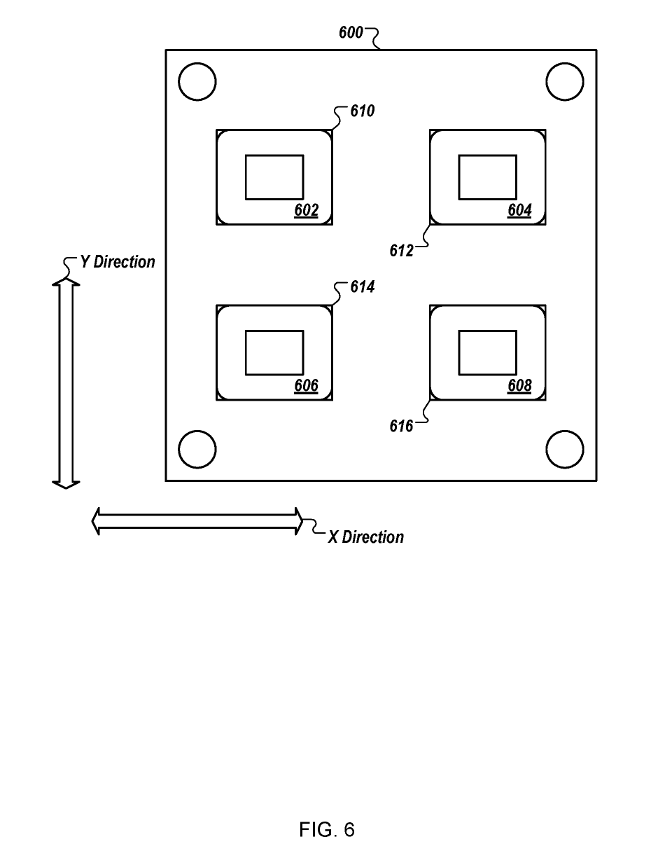

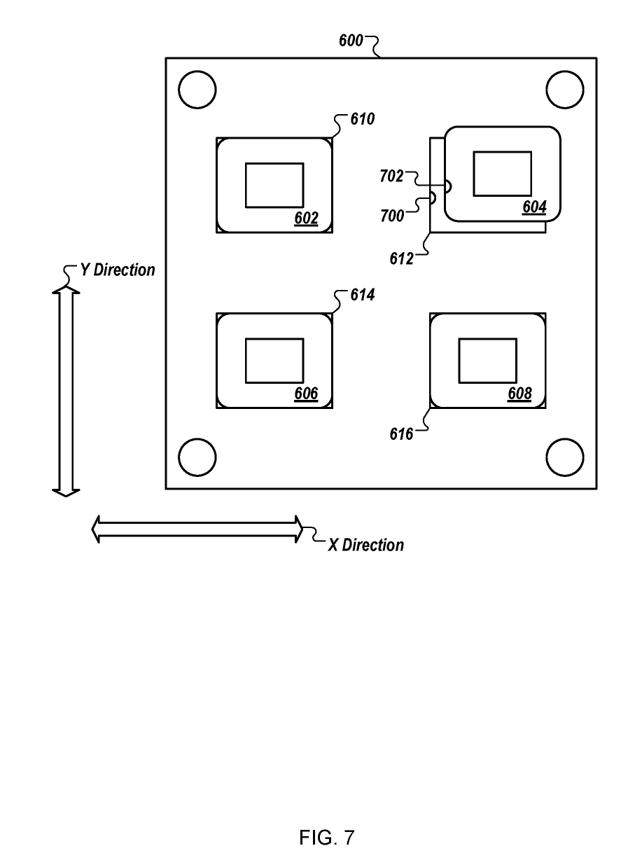

The subplates 102 and 104 can be detachably coupled to the build platform 100 with an appropriate securing feature. In the example shown, the subplates 104 is detachably coupled to the build platform 100 through securing feature 202 and the subplate 102 is detachably coupled to the build platform 100 through the same type of securing feature. The securing feature 202 can include holes 200 (e.g., tapped holes) configured to receive fasteners 106. As used herein, the fasteners 106 can include screws, bolts, studs, pins, etc. In some other examples, other types of securing features may be used. For example, FIGS. 6 and 7 show a baseplate 600 with securing features that include a ball detent and a recess. Other examples can include, but are not limited to, springs and cams. In some embodiments, subplate 102 can be coupled to the build platform 100 through one type of securing feature (e.g., a ball detent and a recess) and subplate can be coupled to the build platform through another type of securing feature (e.g., holes and fasteners). In some embodiments, the build platform 100 can include one or more subplates in addition to the subplates 102 and 104, and one or more securing features in addition to the securing features shown in FIG. 1.

As shown in FIG. 1, each of the subplates 102 and 104 can include a hole (e.g., a screw hole) at each of four corners of the subplate 102 or 104. To couple the subplate 102 or 104 to the build platform, a fastener 106 can pass through the holes in subplate 102 or 104 and secure the subplate to the build platform. For example, the fastener 106 can be machine screws that screw into holes 200 of a securing feature 202 or an unshown securing feature corresponding to the subplate 102 in the build platform 100.

To remove a subplate 102 or 104, and a build piece on the subplate 102 or 104 if one is present, an operator (human, robotic, etc.) can loosen or remove the fastener 106 from the subplate 102 or 104. Removing one subplate 102 or 104 does not necessarily imply or require the removal of the other subplate 102 or 104. For example, the additive-manufacturing device can begin a printing that includes building a first build piece on the subplate 102 and a second build piece on the subplate 104. In this example, the first build piece can be taller (i.e., requiring more layers to print) than the second build piece. When the second build piece's printing is complete, the first build piece's printing can still have additional layers that are to be printed. In this situation, the printing of the first build piece can be paused, the subplate 104 can be removed from the securing feature 202, and then the printing can be resumed. Upon resumption, the additive-manufacturing device can continue to print the first build piece on the subplate 102, regardless of if the subplate 104 is coupled to the build platform or not. This can allow, for example, a finished build piece to be removed before the completion of the printing of another build piece.

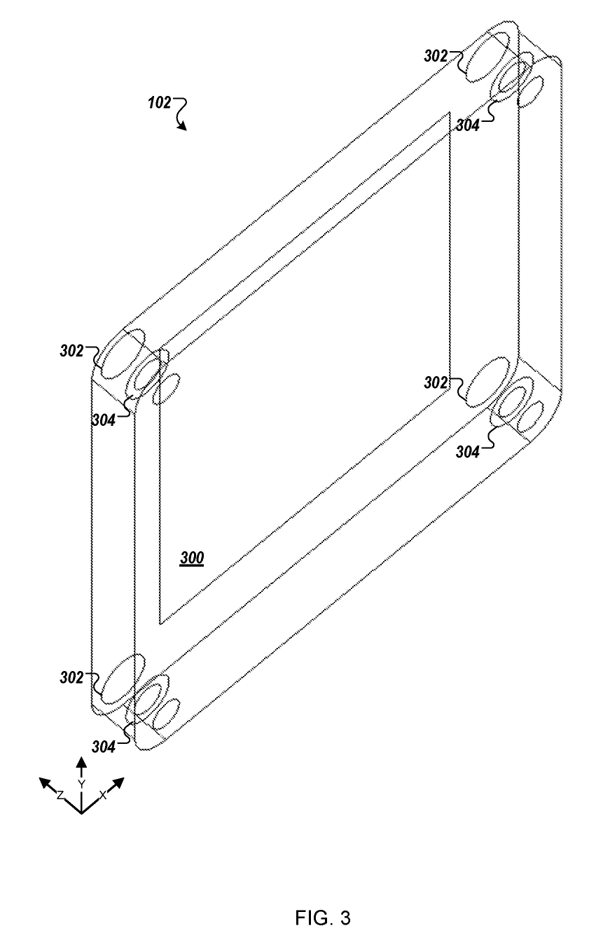

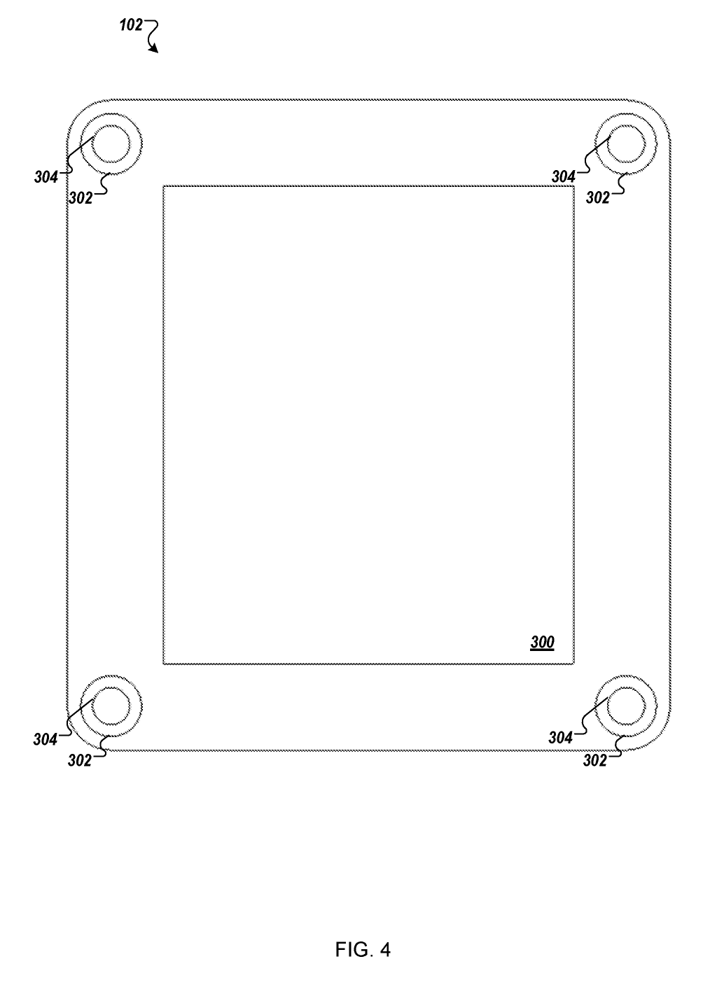

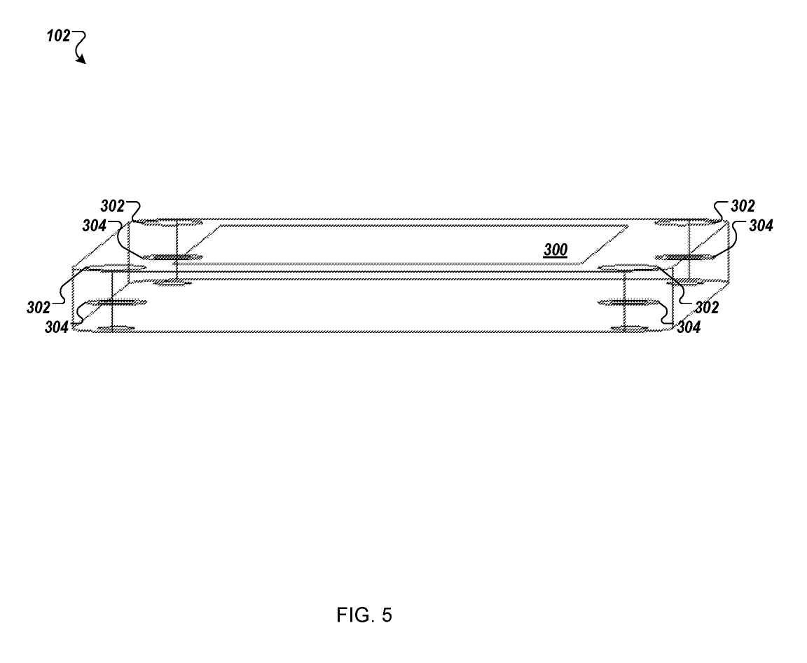

FIG. 3 is an isometric view of an example subplate 102. FIG. 4 is a top view of an example subplate 102. FIG. 5 is a canted side view of an example subplate 102.

As shown in FIG. 3, the subplate 102 includes a print surface 300. The print surface 300 can be printed upon as part of an additive-manufacturing process. For example, in a direct metal printer or fused deposition modeling printer, the print surface 300 can be a made of stainless steel. In many cases, the material may be selected based on the material used to print a build piece. For example, materials may be selected for having a similar coefficient of thermal expansion. As shown here, the print surface 300 can be coplanar with other upper surfaces of the subplate 102. However, in some other examples, the print surface 300 can be elevated or recessed. After the subplate is used, the print surface 300 can be modified. For example, to prepare a used subplate for another print, the print surface 300 can be resurfaced. Resurfacing can be carried out by, for example, grinding, sanding, and/or cleaning the print surface 300. In such embodiments, the subplate 102 can be manufactured with the print surface 300 elevated, in which the print surface 300 is designed to be ablated over the lifetime of the subplate 102. Use of a subplate 102 can thus be beneficial compared to printing directly on a build platform 100, because the print surface 300 can be much smaller than the build platform 100. Therefore, the resurfacing of the build surface 300 can be much faster than resurfacing the entire build platform 100. Similarly, the amount of material ablated can be reduced, which can lead to increase in economic efficiency

The subplate 102 includes four holes 302 that pass through the subplate 102 so that the subplate 102 can be detachably coupled to a securing feature. In this example, each hole 302 can be a screw hole and can include a shelf 304. This shelf 304 is configured to allow the head of a screw to contact the shelf 304 and exert a coupling force on the plate when the screw is screwed into a securing feature such as a tapped hole or nut. The screw holes 302 shown here are untapped. However, in other implementations, the screw holes 302 can be tapped.

FIG. 6 is a top view of an example build platform 600 with four subplates 602, 604, 606 and 608 attached to the build platform 600 through four securing features. FIG. 7 is a top view of an example build platform with three subplate 602, 606 and 608 attached to the build platform 600 through three securing features and one securing feature 612 without any subplate attached to it.

The build platform 600 can be, for example, adjustably coupled to a build chamber of an additive-manufacturing device that is configured to print a build piece on the build platform 100 and/or the subplates 602, 604, 606 and 608.

The subplates 602, 604, 606 and 608 can be detachably coupled to the build platform 600 with an appropriate securing feature 610, 612, 614 and 616. In this example, the securing features 610, 612, 614 and 616 are a ball and detent interfaces in recesses of the build platform 600. Ball and detent interfaces of the securing features 610, 612, 614 and 616 a recess into which the subplates 602, 604, 606, and 608 are placed, and the securing features 610, 612, 614 and 616 include a spring loaded ball, or object of other shape, that is configured to mate with a detent or similar feature in the subplates 602, 604, 606, and 608. When the subplates 602, 604, 606 and 608 are detachably coupled to the build platform 600, the tension of the spring-loaded ball contributes to holding the subplates 602, 604, 606 and 608 to the build platform 600 until removed. In FIG. 7, the subplate 604 has been removed, exposing a portion of the ball 700 that is captured within the build platform 600. A corresponding detent 702 in the subplate 604 would not normally be seen from this view, but for clarity is shown through the top of the subplate 604.

To remove a subplate 602, 604, 606 or 608, and a build piece on a subplate 602, 604, 606 or 608 if one is present, an operator (human, robotic, etc.) can remove a subplate 602, 604, 606 and 608, for example by pulling with sufficient force to overcome the ball and detent's coupling. Removing one subplate 602, 604, 606 and 608 does not necessarily imply or require the removal of one or more of the other subplates. For example, the additive-manufacturing device can begin a printing that includes building a first build piece on the subplate 602 and a second build piece on the subplate 604, possibly with additional build pieces on subplates 606 and/or 608. In this example, the first build piece is taller (i.e., requiring more layers to print) than the second build piece. When the second build piece's printing is complete, the first build piece's printing can still have additional layers that are to be printed. In this situation, the printing can be paused, the subplate 604 can be removed from the securing feature 612, and then the printing can be resumed. Upon resumption, the additive-manufacturing device can continue to print the first build piece on the subplate 602, regardless of if the subplate 604 is coupled to the build platform or not.

Although the baseplate 100 and the baseplate 600 are shown with the same types of securing features (i.e. tapped holes the baseplate 100 and ball and detents in the baseplate 600), a single baseplate may include different types of securing features. For example, a single baseplate may have one securing feature with tapped holes and another securing feature with a ball and detent interface. In this example, a large build piece may be built on a subplate held with the tapped holes, while a smaller build piece (e.g., a calibration piece) may be printed on a subplate held with a ball and detent interface. This may be desirably, for example, to allow the smaller build piece to be removed without the use of tools that might impact and damage the larger build piece while the larger build piece is held in place with a securing feature that permits less play (e.g., movement in the securing feature).

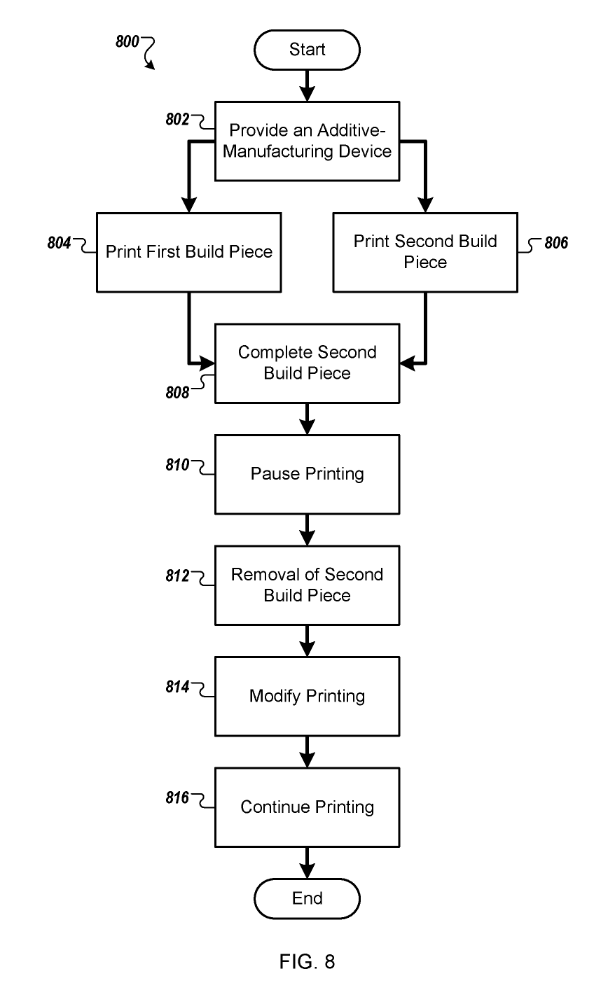

FIG. 8 is a flowchart of an example process 800 for printing build pieces on subplates. The process 800 can be performed by, for example, an additive-manufacturing device having the build platform 100. Therefore, the process 800 will be described with reference to the FIGS. 1 and 2. However, other devices or systems of devices can be used to perform the process 800 or other processes.

The process 800 includes a step 802 of providing an additive-manufacturing device. For example, the additive-manufacturing device can include a build chamber and a build platform 100 adjustably coupled to the build chamber, the build platform 100 comprising a first securing feature and a second securing feature 202, wherein the first securing feature is configured to detachably couple a first subplate 102 to the build platform 100, and the second securing feature 202 is configured to detachably couple a second subplate 104 to the build platform.

The additive-manufacturing device can be a direct metal printer, fused deposition modeling printer, stereolithography printer, or any other technologically appropriate additive-manufacturing device. A print head or energy source, depending on the printer type, can be used by the additive-manufacturing device to iteratively add successive layers to, first, the subplates 102 and 104 and/or other areas of the build platform 100, then to the previous layer of material. In this way, the additive-manufacturing device can additively manufacture one or more build pieces. By way of comparison, a different process that is not additive manufacturing is called stock removal, in which a larger piece of stock is cut, ground, or otherwise reduced in size.

The process 800 includes a step 804 of printing a first build piece and a step 806 of printing a second build piece. In some embodiments, the print head or energy source of the additive-manufacturing device can begin printing the first layer of a first build piece on the subplate 102. After the first layer of the first build piece is printed, the print head or energy source can print the first layer of the second build piece on the subplate 104. In some embodiments, the additive-manufacturing device can print the first layer of the second build piece on the subplate 104 first and then print the first layer of the first build piece on the subplate 102. In some embodiments, the additive-manufacturing device can print the first layer of the first build piece on the subplate 102 and the first layer of the second build piece on the subplate 104 simultaneously.

The additive-manufacturing device can repeat this process with each subsequent layer, for example, printing both second layers of both build pieces before either third layer, printing both third layers of both build pieces before printing either fourth layer, and so on. In some embodiments, the additive-manufacturing device can complete the printing of one of the first and second build pieces before begin printing the other build piece.

The process 800 includes a step 808 of complete the printing of the second build piece. For example, the additive-manufacturing device can receive an indication that the printing has completed the second build piece and not completed the first build piece. For example, the second build piece can be shorter than the first build piece. As such, the second build piece is made of fewer layers than the first build piece and can be completed before the first build piece.

The indication can take any technologically appropriate form. For example, a controller of the additive-manufacturing device can determine that the last layer of the second build piece has completed. In another example, an operator can press an input button or other control to send an indication to the additive-manufacturing device that the printing of the second build piece has completed. This control can be specifically designed to send a signal specifying completion of a build piece, or a general purpose control to pause a build for any reason, or take any other technologically appropriate form.

The process 800 includes a step 810 of pausing the printing (e.g., pausing the printing of the first and second build pieces). For example, responsive to receiving an indication that the printing has completed the second build piece and not completed the first build piece, the printing can be paused. For example, the additive-manufacturing device can stop the printing functions (e.g., energizing an energy source, moving a print head, or moving the build platform 100). Once the printing is paused, other parts of the additive-manufacturing device can be engaged or permitted to be manipulated. For example, automated doors or curtains can open or be opened by a human or robotic operator. The temperature of the build platform 100, a subplate 102 and/or 104, or another feature can be allowed to equalize or held at operating temperature. For example, some types additive-manufacturing devices can heat surfaces onto which build pieces are printed, and the step 810 can include either allowing those surfaces to cool, or to be held at the heated operating temperature. The atmosphere within the additive-manufacturing device can be cycled. For example, some types additive-manufacturing devices can replace the natural atmosphere in a build chamber with a controlled atmosphere for the printing process, and the step 810 can include evacuating that controlled atmosphere and replacing it with natural atmosphere before allowing the build chamber to be opened. Output such as a user display or messages to a remote destination can be issued. A print head or other element can move to allow operator access to a subplate.

The process 800 includes a step 812 of removing the second build piece. For example, a human or robotic operator can remove the subplate 104 and, by extension, the second build piece on the subplate 104. In this example, the four fastener 106 on the subplate 104 can be loosened or removed. The subplate 104 can then be lifted and removed, taking with it the second build piece that has been printed to the subplate 104.

The process 800 includes a step 814 of modifying the printing. For example, the printing of the first build piece can based on measurements of the second build piece. For example, the second build piece can be a calibration piece that is specifically designed to have surfaces that can be measured to calibrate or test the calibration of the additive-manufacturing device. In this example, a human or robotic operator can test the actual printed geometry (e.g., a length, a width, or an area) of these surfaces, input them to the additive-manufacturing device, and compare them to a target geometry. For example, a measuring tool such as calipers may be used to measure the distance between two surfaces of the calibration piece. In another example, a computer vision system may record an image of the calibration piece and measure the distance between pixels of features of the calibration piece.

This information can be used to determine if the additive-manufacturing device is printing with proper calibration, and/or to calibrate the additive-manufacturing device. For example, the operator can test the distance between sets of surfaces in the calibration piece, and enter that data into a calibration program. This program can determine if the additive-manufacturing device is operating within calibration specification, and/or can generate new commands to change the calibration of the additive-manufacturing device.

For example, modifying the printing of the first build piece can include terminating the printing of the first build piece before completion. In some cases, the measurements of the second build piece can indicate that the partially printed first build piece is unsavagably out of specification. In this case, the printing of the first build piece can be terminated, saving the time and materials that can have otherwise been used in building the entire out of specification first build piece.

The process 800 includes a step 816 of continuing the printing. For example, if the printing has not been terminated, the printing of the first build piece on the subplate 102 can continue. This continued printing can use one or more modified parameters that have been modified based on, for example, measurements of the second build piece. For example, based on the calibration piece, it may be determined that one or more settings of the printing should be adjusted. If, for example, the calibration piece is too wide or narrow in the X-direction, the control of a stepper motor controlling travel in the X-direction be modified (e.g., the number of steps used to achieve movement of a particular distance may be increased or decreased). In another example, layers of the calibration piece may be printed with different parameters (e.g., print head speed, temperature). The calibration piece may be inspected, and a parameter giving the most desired result may be identified and input to the additive-manufacturing device.

Although process 800 is described with a particular number, order, and type of elements, other number, orders, and types of elements are possible. For example, instead of printing a calibration piece, a process can print first and second build pieces that are both to be sold as products that can be used to accomplish some task or assembled into a single useful assembly.

In another example, instead of printing multiple build pieces as described, each build piece may be printed to completion before the next build piece is printed. Said another way, the printing may be piece-wise instead of layer-wise. In this example, a first build piece can be printed onto a first subplate. When this first build piece is completed, an operator may remove the first subplate, taking the completed first build piece with it. The printing can then be modified, terminated, or continued. If continued, the second build piece may be printed on the second subplate.

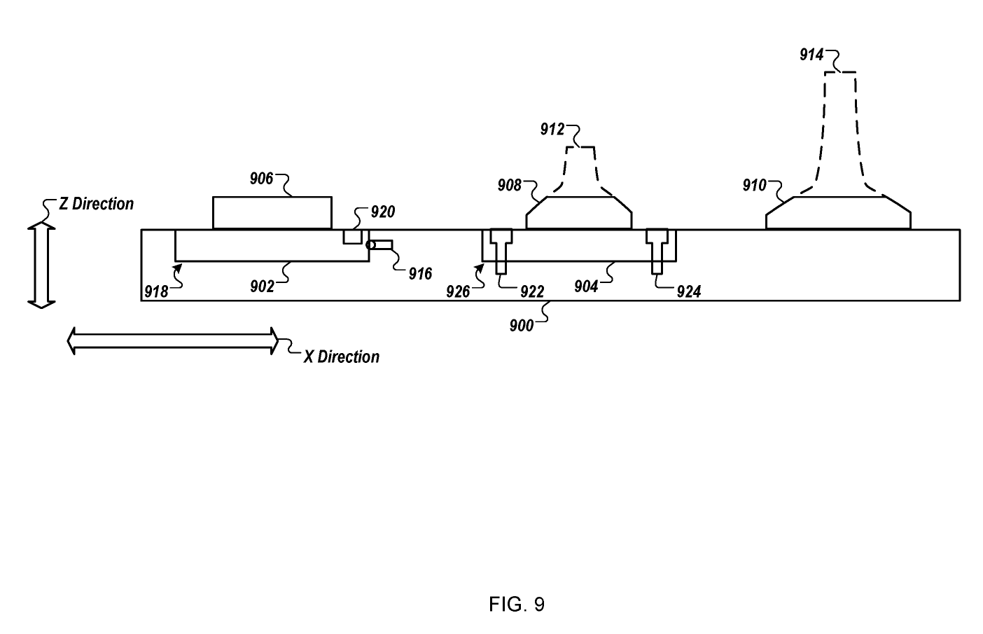

FIG. 9 is a side view of an example build platform 900. This view is a wire-frame view in which the edges of hidden geometry is shown through occluding faces. The build platform 900 includes a subplate 902 and a subplate 904. A build piece 906 is being printed on the subplate 902, a build piece 908 is being printed on the subplate 904, and a build piece 910 is being printed on the build platform 900 directly (i.e. not on a subplate). When completed, the build piece 908 will have a final shape 912 and the build piece 910 will have a final shape 914

In this example, the subplate 902 is detachably coupled to the build platform 900 by a securing feature that includes a ball detent 916 and a recess 918. A channel 920 allows an operator to use, for example, fingers or a tool to remove the subplate 902 from the build platform 900.

In this example, the subplate 904 is detachably coupled to the build platform 900 by a securing feature that includes fasteners 922 and 924 and a recess 926. An operator may use, for example, fingers or a tool to remove the fasteners 922 and 924 to remove the subplate 904.

As shown here, certain build pieces (e.g., build pieces 906 and 908) can be printed onto subplates and certain build pieces (e.g., build piece 910) can be printed on the build platform. In this example, the top surfaces of the build platform 900 and the subplates 902 and 904 are coplanar in the z-direction. In some embodiments, the top surface of the subplate 902 or 904 can be above or below the surface of the build platform 900 in the z-direction.

When the build piece 906 is completed, the subplate 902 can be removed and the printing of the build pieces 908 and 910 can continue. When the build piece 908 is completed, the subplate 904 can be removed and the printing of the build piece 910 can continue. When the build piece 910 is completed, the build piece 910 can be removed from the build platform 900. The build platform 900 may then be prepared and used for another print job, optionally with the subplates 902 and 904, with different subplates installed, or with no subplates.

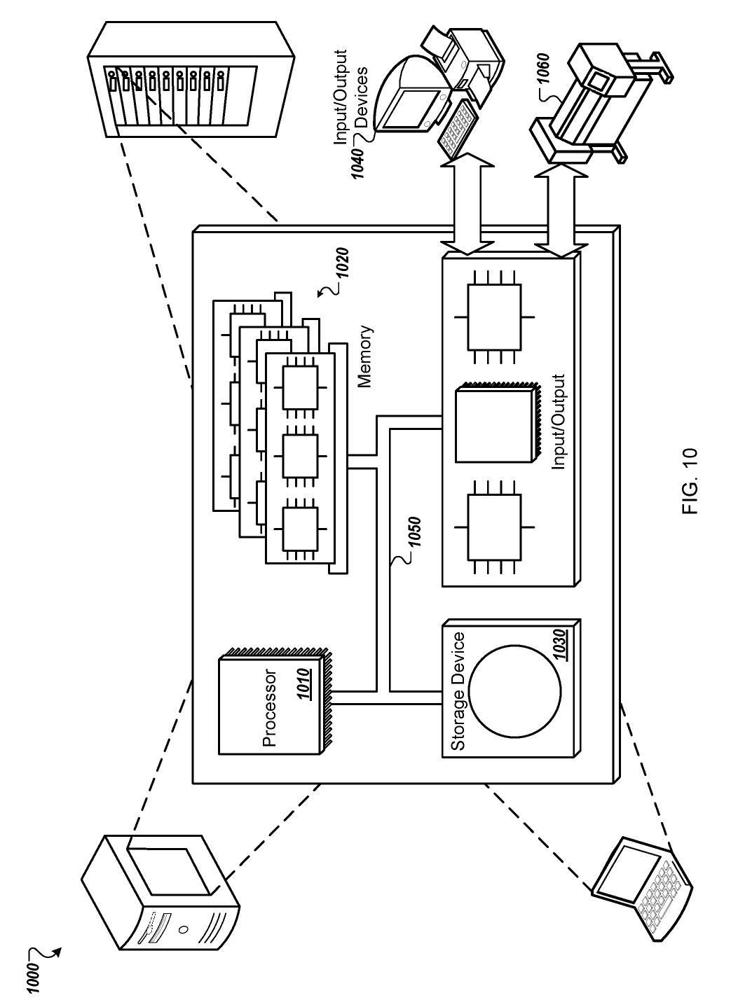

FIG. 10 is a schematic diagram that shows an example of a computing system 1000. The computing system 1000 can be used for some or all of the operations described previously, according to some implementations. The computing system 1000 includes a processor 1010, a memory 1020, a storage device 1030, an input/output device 1040, and an additive-manufacturing device 1060. Each of the processor 1010, the memory 1020, the storage device 1030, the input/output device 1040, and the additive-manufacturing device 1060 are interconnected using a system bus 1050. The processor 1010 is capable of processing instructions for execution within the computing system 1000. In some implementations, the processor 1010 is a single-threaded processor. In some implementations, the processor 1010 is a multi-threaded processor. The processor 1010 is capable of processing instructions stored in the memory 1020 or on the storage device 1030 to display graphical information for a user interface on the input/output device 1040.

The memory 1020 stores information within the computing system 1000. In some implementations, the memory 1020 is a computer-readable medium. In some implementations, the memory 1020 is a volatile memory unit. In some implementations, the memory 1020 is a non-volatile memory unit.

The storage device 1030 is capable of providing mass storage for the computing system 1000. In some implementations, the storage device 1030 is a computer-readable medium. In various different implementations, the storage device 1030 can be a floppy disk device, a hard disk device, an optical disk device, or a tape device.

The input/output device 1040 provides input/output operations for the computing system 1000. In some implementations, the input/output device 1040 includes a keyboard and/or pointing device. In some implementations, the input/output device 1040 includes a display unit for displaying graphical user interfaces.

The additive-manufacturing device 1060 is a device that can manufacture a part by additive manufacturing. Example additive-manufacturing devices 1060 elements to deposit extrusions or bind granular materials according to computer-readable instructions received from the computing system 1000.

Some features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM (erasable programmable read-only memory), EEPROM (electrically erasable programmable read-only memory), and flash memory devices; magnetic disks such as internal hard disks and removable disks; magneto-optical disks; and CD-ROM (compact disc read-only memory) and DVD-ROM (digital versatile disc read-only memory) disks. The processor and the memory can be supplemented by, or incorporated in, ASICs (application-specific integrated circuits).

To provide for interaction with a user, some features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

Some features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN (local area network), a WAN (wide area network), and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

1. A system, comprising:
an additive-manufacturing device comprising:
a build chamber; and
a build platform coupled to the build chamber;
a first subplate detachably coupled to the build platform; and
optionally, a second subplate detachably coupled to the build platform; and
wherein the additive-manufacturing device is configured to print a first build piece on the first subplate when the first subplate is detachably coupled to the build platform.

2. The system of claim 1, wherein the system comprises the second subplate and the additive-manufacturing device is configured to print a second build piece on the second subplate when the second subplate is detachably coupled to the build platform by a securing feature.

3. The system of claim 2, wherein the additive-manufacturing device is configured to pause the printing of the first build piece on the first subplate to allow removal of the second build piece and the second subplate from a securing feature.

4. The system of claim 3, wherein the second build piece is a calibration piece.

5. The system of claim 4, wherein the additive-manufacturing device is configured to modify the printing of the first build piece on the first subplate based on one or more measurements of the second build piece.

6. The system of claim 5, wherein modifying the printing of the first build piece comprises terminating the printing before completion.

7. The system of claim 5, wherein modifying the printing of the first build piece comprises modifying a parameter of the printing based on at least one of the measurements of the second build piece.

8. The system of claim 1, wherein the build platform comprises at least one securing feature for securing at least one of the first subplate and the second subplate, wherein at least one of the securing features comprises holes configured to receive fasteners.

9. The system of claim 1, wherein the build platform comprises at least one securing feature for securing at least one of the first subplate and the second subplate, wherein at least one of the securing features comprises a recess in the build platform.

10. The system of claim 1, wherein the build platform comprises at least one securing feature for securing at least one of the first subplate and the second subplate, wherein at least one of the securing features comprises a ball detent interface.

11. The system of claim 1, wherein the first subplate or the second subplate has an area less than an area of the build platform.

12. The system of claim 1, wherein the build platform further comprises a securing feature; and
wherein the system further optionally comprises a third subplate, the securing feature being configured to detachably couple the third subplate to the build platform.

13. A method comprising:
providing an additive-manufacturing device comprising a build chamber and a build platform coupled to the build chamber, wherein the build platform is configured to detachably couple a first subplate to the build platform, and the build platform is configured to detachably couple a second subplate to the build platform; and
printing first and second build pieces, the printing comprising i) printing a first build piece on a first subplate detachable coupled to the build platform and ii) printing a second build piece on a second subplate detachably coupled to the build platform.

14. The method of claim 13, the method further comprising:
receiving an indication that the printing has completed the second build piece and not completed the first build piece; and
responsive to receiving an indication that the printing has completed the second build piece and not completed the first build piece, pausing the printing.

15. The method of claim 14, further comprising removing the second build piece and the second subplate.

16. The method of claim 15, the method further comprising:
resuming, by the additive-manufacturing device, printing the first build piece after removing the second build piece and the second subplate.

17. The method of claim 16, wherein resuming printing the first build piece comprises receiving an indication that the second subplate has been removed from the build platform.

18. The method of claim 13, wherein the second build piece is a calibration piece.

19. The method of claim 18, further comprising modifying, by the additive-manufacturing device, the printing of the first build piece based on one or more measurements of the second build piece.

20. The method of claim 19, wherein modifying the printing of the first build piece comprises terminating the printing of the first build piece before completion.

21. The method of claim 19, wherein modifying, by the additive-manufacturing device, the printing comprises modifying a parameter of the printing based on at least one of the measurements of the second build piece.

22. The method of claim 13, wherein the build platform comprises at least one securing feature for securing at least one of the first subplate and the second subplate, wherein the securing feature comprises holes configured to receive fasteners.

23. The method of claim 13, wherein the build platform comprises at least one securing feature for securing at least one of the first subplate and the second subplate, wherein the securing feature comprises holes configured to receive fasteners.

24. The method of claim 13, wherein the build platform comprises at least one securing feature for securing at least one of the first subplate and the second subplate, wherein the securing feature comprises holes configured to receive fasteners.

25. The method of claim 13, wherein the build platform further comprises a securing feature.

26. A method comprising:
providing an additive-manufacturing device comprising a build chamber, a build platform coupled to the build chamber, and a first subplate, wherein the first subplate is detachably coupled to the build platform; and
printing first and second build pieces, the printing comprising i) printing the first build piece on the first subplate and ii) printing the second build piece on the build platform outside the first subplate.

27. A build platform device, comprising:
a first securing device configured to detachably couple a first subplate to the build platform device; and
a securing device configured to detachably couple a second subplate to the build platform device.
